(19) United States
(12) Patent Application Publication
(10) Pub. No.: US 2025/0137532 A1
(43) Pub. Date: May 1, 2025

(54) METAL BAND

(71) Applicant: BFC FAHRZEUGTEILE GMBH, Bietigheim-Bissingen (DE)

(72) Inventor: Timo STAIBER, Bietigheim-Bissingen (DE)

(73) Assignee: BFC FAHRZEUGTEILE GMBH, Bietigheim-Bissingen (DE)

(21) Appl. No.: 18/685,117

(22) PCT Filed: Sep. 1, 2022
(86) PCT No.: PCT/EP2022/074383

§ 371 Date: Feb. 20, 2024

(30) Foreign Application Priority Data
Sep. 2, 2021 (DE) 20 2021 104 735.6

(51) Int. Cl. F16J 15/34

(52) U.S. Cl. CPC F16J 15/3452

(57) ABSTRACT

A metal band as an inlay for trim strips or sealing strips or as edge protection, in particular for motor vehicles or switch cabinets, said metal band being provided with cut and/or punched apertures, wherein the metal band consists of microalloyed steel or multiphase steel.

### CROSS-REFERENCE TO RELATED APPLICATIONS

This application claims foreign priority benefits under 35 U.S.C. § 119 to German Patent Application No. 20 2021 104 735.6 filed Sep. 2, 2021 and International Patent Application No. PCT/EP2022/074383 filed Sep. 1, 2022, the contents of which are hereby incorporated by reference in their entireties.

### FIELD OF THE INVENTION

The present invention relates to a metal band as an inlay for trim strips or sealing strips or as edge protection, in particular for motor vehicles or switch cabinets, said metal band in particular being provided with cut and/or punched apertures.

### BACKGROUND OF THE INVENTION

Such metal bands are in particular used in the automotive sector as inlays for sealing strips for sealing engine compartment openings, trunk openings, and door openings. The continuously produced metal bands are jacketed by rubber and/or a flexible plastic and have slots in order, among other things, to enable a penetration of the sealing material in the case of metal bands not coated with an adhesive means since the adhesion between the rubber and the metal or between the plastic and the metal is not possible. On the other hand, metal bands coated with an adhesive means are very expensive. In addition to slots, which can in particular be produced by rotary cutting, such metal bands can also have punched apertures. Cut or punched slots can be widened by rolling stretching.

Before or after the jacketing with the sealing material, metal bands of said kind are bent into a clamping profile that is usually of U shape and that is clamped onto the sealing flanges of the opening. In order in this respect to be able to follow the contours of the opening, the clamping profile usually has to be flexible both in the horizontal plane and in the vertical plane. In addition, the clamping profile should be compressible and/or stretchable in the longitudinal direction since the openings to be sealed can have considerable peripheral tolerances and a cutting to length of the sealing strip on site would be very complex and/or expensive.

On the other hand, the clamping profile also has to have a specific tensile strength since the trim strips or sealing strips are usually manufactured by extrusion, with considerable forces occurring in the longitudinal direction of the band. A further requirement of the clamping profile comprises exerting a clamping force which is as large as possible onto the sealing flanges.

To meet these requirements, known metal bands of said kind consist of steel and have a material thickness of 0.5 mm and more. Steels of the category DIN EN 10139 DC01/03/04 C390, C490 and C590 are in particular used. Furthermore, bands composed of aluminum-magnesium alloys EN AW 5052 and/or EN AW 5754 are used.

### SUMMARY OF THE INVENTION

It is the underlying object of the invention to provide a metal band of the initially named kind that satisfies the requirements mentioned, but has the lowest possible weight in this respect. In addition, the material use for the metal bands or the trim strips or sealing strips produced thereby should be reduced.

This object is satisfied by a metal band according to the independent claims.

Microalloyed steel, also known as HSLA steel, is steel to which very small quantities of vanadium and/or niobium and/or titanium have been added as alloys. The proportion of the elements added as alloys in total in particular lies between 0.03 and 0.3%.

Multiphase steel is to be understood as steel that has a basic structure of ferrite and bainite, in which portions of residual austenite are embedded, and that is additionally strengthened by very fine deposits. On the reshaping, the austenite portions are transformed into hard martensite, whereby the steel obtains a very high strength, in particular a tensile strength of up to 800 MPa, and a very good ductility, namely an elongation at break of up to 40% in the initial state.

By using microalloyed steel or multiphase steel, a high tensile strength can already be achieved with a smaller material thickness. It is therefore possible to produce metal bands for the above-mentioned purposes of use that have a material thickness of 0.4 mm or less. Weight is thereby saved. Furthermore, the amount of sealing material by which the band has to be enveloped is thereby reduced.

The materials specified in the independent claims have proven to be particularly advantageous. DIN EN 10268 in this respect refers to the German version of September 2013 of the European standard EN 10268: 2006, DIN EN 10338 in this respect refers to the German version of October 2015 of the European standard EN 10338:2015, DIN EN 10346 refers to the German version of October 2015 of the European standard EN 10346: 2015, VDA 239-100 refers to the material sheet of the German Association of the Automotive Industry (VDA) of May 2016, GB/T 1591 refers to the National Standard of the People's Republic of China, issue date Dec. 6, 2008, and ASTM A 1008 refers to the US Standard A 1008/A 1008M-05a of ASTM International.

The metal band preferably consists of hot-formed steel or cold-formed steel. Particularly good properties, in particular high tensile strengths with a simultaneously high stretchability, of the microalloyed steel or of the multiphase steel can hereby be achieved.

According to a preferred embodiment, the metal band has a material thickness of 0.4 mm or less, preferably 0.35 mm or less, in particular 0.3 mm or less. The weight reduction and also the reduction of the required sealing material can hereby be optimized.

The metal band according to the invention can be coated. The manufacture of the metal band can take place by rotary cutting or punching and rolling stretching.

The invention also relates to a sealing strip or an edge protection strip, in particular for closable vehicle openings such as windows, doors and flaps, comprising a metal band according to the invention. The metal band serves as an inlay of the sealing strip or edge protection strip and can be enveloped by sealing material. The sealing strip or edge protection strip has the advantages described.

The metal band in the sealing strip or edge protection strip is preferably bent into a U-shaped or S-shaped clamping profile. The metal band can hereby be fastened in a simple manner in a vehicle opening or at an edge.

### BRIEF DESCRIPTION OF THE DRAWINGS

Embodiments of the invention are shown in the drawing and will be described in the following. There are shown, in a schematic representation in each case:

FIG. 1 is a plan view of a first embodiment of the metal band according to the invention;

FIG. 2 is a front view of the metal band of FIG. 1 in an enlarged representation, viewed in the longitudinal direction of the metal band;

FIG. 3 is a plan view of a second embodiment of a metal band according to the invention;

FIG. 4 is a front view of the metal band of FIG. 3 in an enlarged representation, viewed in the longitudinal direction of the metal band; and

FIG. 5 is a perspective view of a third embodiment of the metal band according to the invention in a sealing strip during the cutting to length of the sealing strip.

### DETAILED DESCRIPTION

The metal band, which is shown in FIG. 1 and which can be used as an inlay for trim strips or sealing strips of a flexible material, in particular of rubber or plastic, or as edge protection, has a plurality of marginal slots 1 that periodically follow one another in the longitudinal direction I of the band and that are inwardly guided disposed opposite one another in pairs from the two margins 2 of the metal band. The marginal slots 1 have a length I₁ that corresponds to approximately three eighths of the width b of the metal band. Between two respective consecutive pairs of marginal slots 1, the metal band furthermore has a respective central slot 3 whose length I₂ amounts to approximately half of the band width b. The central slots 3 thereby slightly overlap, namely by approximately a twelfth of the width b, with the marginal slots 1 in the transverse direction II of the metal band.

The marginal slots 1 and the central slots 3 are produced by cutting and rolling stretching and are thereby widened in the longitudinal direction I of the metal band. The marginal slots 1 have a shape which runs out into a wedge tip 4 at the inner band side, whereas the central slots 3 each run out into a wedge tip 5 toward the two margins of the metal band.

In addition to the marginal slots 1 and the central slots 3, the metal band is provided with cut-through portions 6 that extend transversely to the longitudinal direction I of the metal band and that are likewise produced by cutting, but are not widened, and that each extend from a margin 2 of the metal band in the direction of the wedge tip 5 of a central slot 3 disposed opposite the margin 2. A respective only short non-cut through region 8 is located between the end 7 of the cut-through portions 6 that is at the inner band side and the respective oppositely disposed wedge tip 5 of the central slots 3. This region in particular has an extent a in the transverse direction II of the metal band of less than 0.5 cm, in the embodiment shown of approximately 0.4 cm.

In the embodiment of FIG. 1, the central slots 3 are arranged symmetrically to the central longitudinal axis III of the metal band. As shown in FIG. 1, their length 12 is selected to be so large that the central slots 3 extend up to and into the limbs 9 of the U profile 10 formed from the metal band. The extent of the central slots 3 into the limbs 9 of the U profile 10 is, however, only short in relation to their length 12.

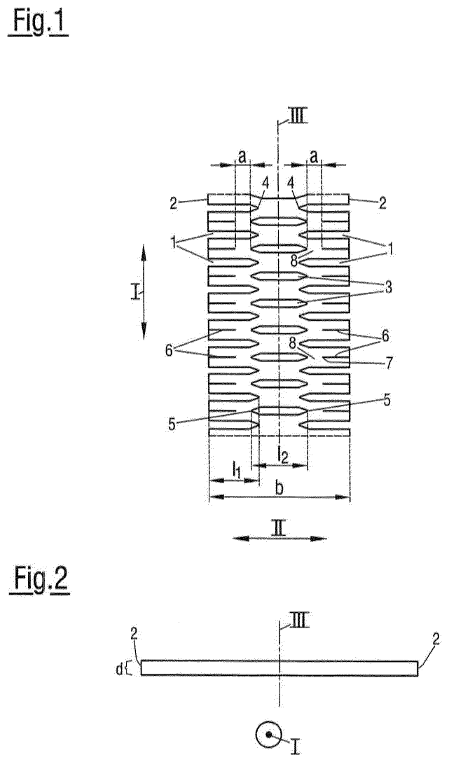

As shown in FIG. 2, the metal band has a comparatively small material thickness d. The material thickness can amount to 0.4 mm or less. In addition to the material savings, a low weight thereby also results. Furthermore, less sealing material is needed to envelop the metal band.

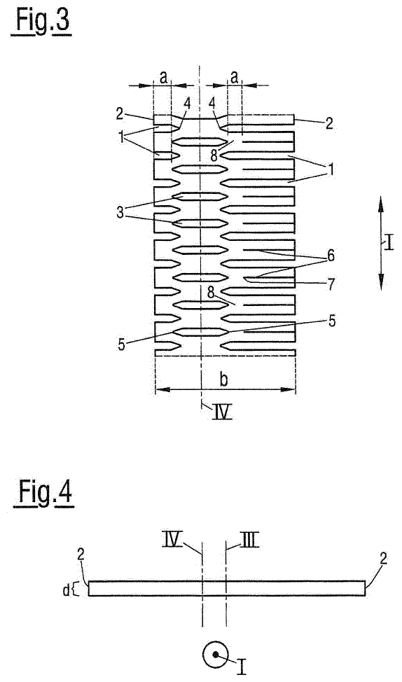

In the embodiment shown in FIG. 3, the central slots 3 are not arranged symmetrically to the central longitudinal axis III of the metal band, but to a longitudinal axis IV in parallel therewith. The marginal slots 1 also have such a length I₁ in this embodiment that the marginal slots only slightly overlap with the central slots 3 in the transverse direction II of the metal band. Accordingly, the marginal slots 1 extending from the left margin in FIG. 3 to the band interior have a smaller length than the marginal slots 1 extending from the right margin in FIG. 3 to the band interior. The size of the overlap corresponds to that of the embodiment of FIG. 1.

Furthermore, in this embodiment, cut-through portions 6 are only provided at the side of the long marginal slots 1 of the metal band, i.e. only starting from the right margin in FIG. 2. The non-cut through region 8 between the ends 7 at the inner band side and the respective oppositely disposed wedge tip 5 of the central slots 3 also has an only short length a of preferably less than 0.5 cm here, in particular in accordance with the embodiment of approximately 0.4 cm. Due to the asymmetrical arrangement of the central slots 3, the spacing of the other wedge tips 5 of the central slots 3 from the left margin 2 of the metal band likewise only have a small size, in particular in the embodiment shown of approximately 0.5 cm. The advantages described therefore also result on the cutting to length of this metal band without cut-through portions at the left side of the metal band. It is, however, also possible with an asymmetrical arrangement of the central slots 3 to provide cut-through portions 6 at both sides of the metal band, i.e. starting from both margins 2.

FIG. 4 again shows the comparatively small material thickness d of the metal band of FIG. 3.

In both the first embodiment and the second embodiment, the metal band consists of a cold-formed or hot-formed microalloyed steel. A high strength hereby results. Thus, the tensile strength Rₘ can amount to more than 750 MPa. Advantageous properties of a trim strip or sealing strip or edge protection strip can thus be achieved.

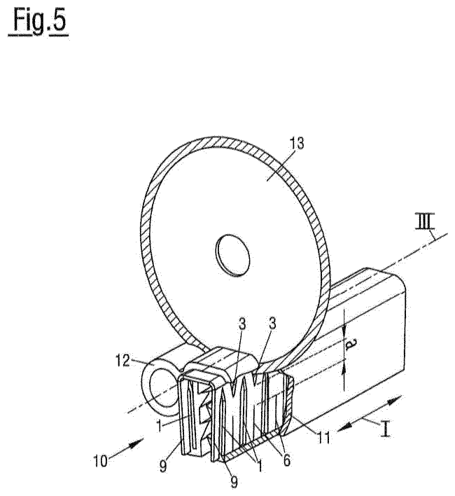

FIG. 5 shows the cutting through of a clamping profile equipped with a metal band according to the invention. The metal band is bent into a U profile 10 and is jacketed by a sealing material 11. The clamping profile additionally has a sealing lip 12.

A separating disk 13, whose drive is not shown, is used to cut through the clamping profile in the example shown. The separating disk can automatically be positioned at one of the central slots 3. A cutting through of the clamping profile can thereby take place at a position at which only short, non-cut through regions, namely the regions 8 between the wedge tips 5 of the central slot 3 and the two oppositely disposed cut-through portions 6, are present. These regions 8 have an only short length a of approximately 0.4 cm. As a result, and due to the small material thickness of the band, only a small energy input is required for cutting through the clamping profile, whereby a slight impairment of the clamping profile results. In addition, smooth cut surfaces can be obtained in the region of a central slot 3 on the cutting through of the clamping profile. Furthermore, relatively few contaminants are produced by chip formation in the separation process. The susceptibility to corrosion is thus also reduced.

### LIST OF REFERENCE SYMBOLS

1 marginal slot
2 margin
3 central slot
4 tip of 1
5 tip of 3
6 cut-through portion
7 end of 6
8 non-cut through region
9 limbs of 10
10 U profile
11 jacket
12 sealing lip
13 separating disk
a length of 8
b width of the metal band
d material thickness of the metal band
I₁ length of 1
I₂ length of 3
I longitudinal direction of the metal band
II transverse direction of the metal band
III central longitudinal axis of the metal band
IV parallel axis to III

1. A metal band as an inlay for trim strips or sealing strips or as edge protection, wherein
the metal band consists of microalloyed steel or multiphase steel, namely of at least one of the following materials:
DIN EN 10268 HC260LA—material number: 1.0480
DIN EN 10268 HC300LA—material number: 1.0489
DIN EN 10268 HC340LA—material number: 1.0548
DIN EN 10268 HC380LA—material number: 1.0550
DIN EN 10268 HC420LA—material number: 1.0556
DIN EN 10268 HC460LA—material number: 1.0574
DIN EN 10268 HC500LA—material number: 1.0573
DIN EN 10338 HCT590X—material number: 1.0996
DIN EN 10338 HCT690T—material number: 1.0947
DIN EN 10338 HCT600C—material number: 1.0953
DIN EN 10346 HDT950C—material number: 1.0958
VDA 239-100 HR500LA
VDA 239-100 HR550LA

2. A metal band as an inlay for trim strips or sealing strips or as edge protection,
wherein
the metal band consists of microalloyed steel or multiphase steel, namely of at least one of the following materials:
GB/T 1591 Q345 B
GB/T 1591 Q390 B
GB/T 1591 Q420 B
GB/T 1591 Q460 B
GB/T 1591 Q690 E.

3. A metal band as an inlay for trim strips or sealing strips or as edge protection, wherein
the metal band consists of microalloyed steel or multiphase steel, namely of at least one of the following materials:
ASTM A1008 HSLA-S; Grade 50
ASTM A1008 HSLA-S; Grade 60.

4. The metal band according to claim 1, wherein
the metal band consists of hot-formed steel or cold-formed steel.

5. The metal band according to claim 1, wherein
the material thickness of the metal band amounts to 0.4 mm or less.

6. The metal band according to claim 1, wherein
the metal band is coated.

7. The metal band according to claim 1, wherein
the metal band is produced by rotary cutting or punching and rolling stretching.

8. A sealing strip, or an edge protection strip, comprising a metal band, wherein the metal band consists of microalloyed steel or multiphase steel, namely of at least one of the following materials:
DIN EN 10268 HC260LA—material number: 1.0480
DIN EN 10268 HC300LA—material number: 1.0489
DIN EN 10268 HC340LA—material number: 1.0548
DIN EN 10268 HC380LA—material number: 1.0550
DIN EN 10268 HC420LA—material number: 1.0556
DIN EN 10268 HC460LA—material number: 1.0574
DIN EN 10268 HC500LA—material number: 1.0573
DIN EN 10338 HCT590X—material number: 1.0996
DIN EN 10338 HCT690T—material number: 1.0947
DIN EN 10338 HCT600C—material number: 1.0953
DIN EN 10346 HDT950C—material number: 1.0958
VDA 239-100 HR500LA
VDA 239-100 HR550LA
GB/T 1591 Q345 B
GB/T 1591 Q390 B
GB/T 1591 Q420 B
GB/T 1591 Q460 B
GB/T 1591 Q690 E
ASTM A1008 HSLA-S; Grade 50
ASTM A1008 HSLA-S; Grade 60.

9. The sealing strip or edge protection strip according to claim 8, wherein
the sealing strip or edge protection strip is provided with an envelope composed of sealing material.

10. The sealing strip or edge protection strip according to claim 8,
wherein
the metal band is bent into a U-shaped clamping profile.

11. The metal band of claim 1 configured for motor vehicles or switch cabinets.

12. The metal band of claim 1, wherein said metal band is provided with cut and/or punched apertures.

13. The metal band according to claim 2,
wherein the metal band consists of hot-formed steel or cold-formed steel.

14. The metal band according to claim 3,
wherein the metal band consists of hot-formed steel or cold-formed steel.

15. The metal band according to claim 2,
wherein the material thickness of the metal band amounts to 0.4 mm or less.

16. The metal band according to claim 3,
wherein the material thickness of the metal band amounts to 0.4 mm or less.

17. The metal band according to claim 2,
wherein the metal band is coated.

18. The metal band according to claim 3,
wherein the metal band is coated.

19. The metal band according to claim 2,
wherein the metal band is produced by rotary cutting or punching and rolling stretching.

20. The metal band according to claim 3,
wherein the metal band is produced by rotary cutting or punching and rolling stretching.

21. The sealing strip or edge protection strip according to claim 8, wherein the sealing strip is configured for closable vehicle openings.
